(19) United States
(12) Patent Application Publication
(10) Pub. No.: US 2011/0189504 A1
(43) Pub. Date: Aug. 4, 2011

(54) PREPARATION OF METAL CARBIDE FILMS

(75) Inventors: Guifu Zou, Los Alamos, NM (US); Hongmei Luo, Los Alamos, NM (US); Quanxi Jia, Los Alamos, NM (US); Thomas Mark McCleskey, Los Alamos, NM (US); Anthony K. Burrell, Los Alamos, NM (US)

(73) Assignee: LOS ALAMOS NATIONAL SECURITY, LLC, Los Alamos, NM (US)

(21) Appl. No.: 12/697,877

(22) Filed: Feb. 1, 2010

(51) Int. Cl. B32B 9/00; B05D 3/02; B05D 3/04

(52) U.S. Cl. 428/698; 427/350; 977/778

(57) ABSTRACT

A coating solution including a polymer and a metal selected from scandium, yttrium, titanium, zirconium, hafnium, vanadium, niobium, tantalum, chromium, molybdenum, tungsten, boron, aluminum and silicon can be deposited on a substrate and then exposed at elevated temperature to a reducing atmosphere including a gaseous carbon source. Solvent evaporates and the polymer decomposes and a metal carbide film forms on the substrate. Metal carbide films of titanium carbide, vanadium carbide, niobium carbide, tantalum carbide, tungsten carbide, silicon carbide, and several mixed carbides were prepared. X-Ray diffraction patterns of metal carbide films provide evidence of a highly ordered structure and excellent alignment with the substrate. A composite film of niobium carbide and carbon nanotubes was also prepared.

STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates to the preparation of metal carbide films.

### BACKGROUND OF THE INVENTION

Metal carbides possess exceptional hardness, high temperature stability, low electrical resistivity, and high resistance to corrosion and oxidation. Titanium carbide, for example, shows excellent hardness, high Young's modulus, low coefficient of friction, and good oxidation resistance. Niobium carbide has high hardness, an extremely high melting temperature (3600 K), and also superconducting properties with a transition temperature of about 11 K. These properties make metal carbides potential candidates for a wide range of applications including light wear coatings, passivation layers, and high temperature electronic materials. Metal carbides have been used in rocket nozzles, optical coatings, electronic contacts, diffusion barriers, drill bits, cutting tools, golf spikes, etc.

For many applications, metal carbides need to be in the form of film. Metal-carbide films have been prepared using various physical and chemical deposition techniques. Some of the physical deposition techniques include pulsed laser deposition, reactive laser ablation, ultrahigh vacuum sputter deposition, high current plasma discharge arc deposition, and co-evaporation in an ultrahigh vacuum system. For example, chemical vapor deposition (“CVD”), electron beam deposition (“EBD”), and ion beam assisted deposition (“IBAD”) have been used to deposit NbC and TiC films.

### SUMMARY OF THE INVENTION

The present invention provides for a process of preparing metal carbide films. According to the process, a homogeneous coating solution including a soluble metal precursor, a soluble polymer and a suitable solvent is deposited on a substrate. Metals suitable for the formation of metal carbide films according to this invention are scandium, yttrium, titanium, zirconium, hafnium, vanadium, niobium, tantalum, chromium, molybdenum, tungsten, boron, aluminum and silicon. The transition metals are from Groups 3, 4, 5, and 6. Boron and aluminum are from Group 13 and silicon is in Group 14. Carbides of the lanthanides and actinides can be also prepared by the process. The soluble polymer is a polymer that binds to the soluble metal precursor, and may include polyethyleneimine (“PEI”) and PEI derivatives such as carboxylated PEI. The coated substrate is heated in a reducing atmosphere that includes a carbon source. As the coated substrate is heated, the solvent evaporates and the polymer decomposes. After polymer decomposition, the carbon source gas decomposes and a film of metal carbide forms on the substrate.

The present invention also provides a process for preparing metal carbide films. According to the process, a homogeneous coating solution is deposited onto a substrate to form a coated substrate, the coating solution including a soluble metal precursor, a soluble polymer and a suitable solvent, the soluble polymer binding to the soluble metal precursor. The coated substrate is heated in a reducing atmosphere that includes inert gas and argon at temperatures and for times characterized as sufficient to evaporate the solvent and remove the polymer. A carbon source gas is added to the reducing atmosphere and the substrate is heated at temperatures and for times characterized as sufficient to form a metal carbide film on the support. After forming the metal carbide film, the addition of the carbon source gas is discontinued and then the supported metal carbide film is heated at temperatures and for times characterized as sufficient to anneal the metal carbide film.

The present invention also provides for a composite film on the substrate wherein the composite film comprises of niobium carbide and carbon nanotubes, and the composite film has a critical current density (Jc) greater than the Jc of niobium carbide without the carbon nanotubes.

### BRIEF DESCRIPTION OF THE DRAWINGS

FIG. 1 shows an x-ray diffraction pattern (“XRD”) of a titanium carbide film grown on a c-plane sapphire substrate as per example 8; (a) a θ-2θ scan showing the alignment of the film with respect to the sapphire; (b) a rocking curve from a (111) reflection that indicates a highly ordered film; and (c) φ scans from (200) and (104) reflection of the titanium carbide film and the Al₂O₃ substrate, which respectively confirm the ordering of the titanium carbide film with respect to the substrate.

FIG. 2 shows the hardness (top panel) and Young's modulus (bottom panel) of an epitaxial titanium carbide (‘TiC”) film on c-plane sapphire substrate as a function of penetration depth. These measurements confirm that the films created by Example 8 have hardness values consistent with the standard hardness of titanium carbide which is in the range of 26-31 GPa.

FIG. 3 shows an XRD pattern of a vanadium carbide thin film, prepared from Example 12 on a sapphire substrate, the XRD pattern demonstrating the alignment of the vanadium carbide film with respect to the substrate.

FIG. 4 shows an XRD pattern of a tantalum carbide, prepared from Example 11, thin film on a sapphire substrate, the XRD pattern demonstrating the alignment of the tantalum carbide film with respect to the substrate.

FIG. 5 shows an XRD θ-2θ scan pattern of a silicon carbide thin film on a silicon (111) substrate, the XRD pattern demonstrating the alignment of the silicon carbide film with respect to the Si substrate. The XRD data shown are from a film prepared using Example 17. The θ-2θ scan patterns for all of the silicon carbide samples prepared in examples 17-21 were identical.

FIG. 6 shows an XRD φ scan from a silicon carbide thin film (top panel) on a silicon (111) substrate (bottom panel) film, prepared according to Example 16. As FIG. 6 shows, there is a high degree of crystallographic alignment between the silicon substrate and the thin film of silicon carbide.

FIG. 7 shows an XRD pattern of a niobium carbide film, prepared from example 14, on a c-plane sapphire substrate; (a.) a θ-2θ scan; (b) a rocking curve from a (111) reflection; and (c) φ-scans from (200) and (104) reflections of the niobium carbide film (top) and the sapphire substrate (bottom), respectively.

FIG. 8 shows a plot of resistivity versus temperature of a niobium carbide film. As the plot shows, there is a superconducting transition at a temperature of 8 degrees Kelvin for a sample prepared according to Example 14.

FIG. 9 shows two graphs; the graph on the left is hardness versus penetration depth of a niobium carbide (“NbC”) film, and the graph on the right is Young's modulus versus penetration depth for the niobium carbide film for a sample prepared according to Example 13. These measurements confirm that the films created by Example 13 have hardness values consistent with the standard hardness of niobium carbide which is 21 GPa.

FIG. 10 shows an XRD pattern of a niobium carbide-carbon nanotube composite film prepared using example 23. The XRD pattern confirms the formation of niobium carbide as a polycrystalline film and the presence of the carbon nanotubes in the film.

FIG. 11 shows a plot of the temperature dependence of electric and magnetic properties for the niobium carbide-carbon nanotube composite film, prepared according to Example 23, when the magnetic field is applied parallel to the film. From the plot, the presence of the carbon nanotubes significantly improves the critical current compared to a film without the carbon nanotubes.

### DETAILED DESCRIPTION

The present invention is concerned with the preparation of metal carbide films. The process involves depositing a homogeneous solution of a metal precursor and soluble polymer in a suitable solvent onto a substrate. The soluble polymer assists in the deposition, thus the process can thus be referred to as a “polymer-assisted deposition” (“PAD”) process. Afterward, the solvent is evaporated and the polymer removed by heating at sufficiently high temperatures under a reducing atmosphere. The solvent evaporates first, and afterward the polymer decomposes. A carbon source gas in the reducing atmosphere reacts with metal on the substrate to form the metal carbide film. The metal carbide film can be amorphous. The metal carbide film can also be highly oriented with a preferred orientation, e.g. the metal carbide film can have a highly ordered structure such as an epitaxial structure. Metal precursors include metals that are suitable for the formation of metal carbide films include scandium, yttrium, titanium, zirconium, hafnium, vanadium, niobium, tantalum, chromium, molybdenum, tungsten, boron, aluminum and silicon. The transition metals are from Groups 3-6. Boron and aluminum are also suitable for forming boron carbide and aluminum carbide, and are from group 13. Silicon is in group 14. Carbides of the lanthanides and actinides may be prepared using the same process.

In an embodiment, after the solution of metal an polymer is deposited on the substrate, the coated substrate is heated under a reducing atmosphere of forming gas, which is a gas made up from about 90% to about 99% Argon and from about 1% to about 10% H₂. Hydrogen is the reducing agent. The heating continues until the solvent is evaporated and the polymer decomposes, after which the carbon source is added and the temperature is increased so that the carbon source gas can react with the metal to produce the metal carbide film. After the decomposition, the structure can be annealed at still higher temperature.

In another embodiment, after the solution of metal and polymer is deposited on the substrate, the coated substrate is heated under a reducing atmosphere that includes both the forming gas and the carbon source gas.

In still another embodiment, after the solution is deposited on the substrate, the coated substrate is heated under a reducing atmosphere that includes the carbon source gas but does not include hydrogen or an inert gas.

It is preferable that the initial heating of the substrate with polymer and metal solution deposited thereon be under a reducing atmosphere of forming gas (a gaseous mixture of hydrogen and argon) prior to adding the carbon source gas. It is also preferred for reasons of safety that the reducing atmosphere also includes an inert gas, such as argon, helium, or nitrogen. Argon is a preferred inert gas.

Other gases besides forming gas can be used, i.e. the hydrogen can be replaced with other reducing agents such as, but not limited to, ammonia, formaldehyde, carbon monoxide, and formic acid. It is preferred for reasons of safety that the reducing atmosphere includes inert gas such as argon, helium, and/or nitrogen. Suitable gaseous carbon sources include hydrocarbons (e.g. ethylene, methane, acetylene), and alcohols (e.g. ethanol).

Metal carbide films prepared according to this invention are uniform films, i.e., they are continuous films covering the target substrate. They can also be readily formed as conformal films upon non-planar substrates or surfaces.

The soluble polymer used in the present process binds to the metal precursors through any of various mechanisms such as electrostatic attraction, hydrogen bonding, covalent bonding and the like.

The polymers should be soluble, compatible with the metal precursors, and also undergo a clean decomposition upon heating at high temperatures, e.g., temperatures over about 250° C. Preferred soluble polymers include polyethylenimine (PEI) and PEI derivatives such as a carboxylated-polyethylenimine (PEIC), a phosphorylated-polyethylenimine (PEIP), a sulfonated-polyethylenimine (PEIS), an acylated-polyethylenimine, hydroxylated water-soluble polyethylenimines and the like. The soluble polymer can also be a polymer such as polyacrylic acid, polypyrolidone, and poly(ethylene-maleic acid). Because PEI decomposes completely and cleanly above 250° C. and leaves little or no residual carbon in the film, PEI and PEI derivatives are preferred polymers. Typically, the molecular weight of such polymers is greater than about 30,000.

The solutions of soluble polymer and metal precursor that are used in depositing the polymer and metal on the substrates are homogeneous solutions. By “homogeneous” is meant that the solutions are not dispersions or suspensions, but are actual solutions of the polymer, metal complexes and any metal binding ligands.

The soluble polymer, besides aiding in the deposition, also aids in attaining a suitable viscosity for allowing processing of the metal carbide precursor solution into desired configurations such as films. The desired viscosity can be achieved through controlling the solution concentration of the soluble polymers and by controlling the molecular weight of the polymer. For high quality homogeneous films, polymer concentrations and the polymer ratio to metal components should be maintained at a proper balance. The rheology of the metal carbide precursor solution can also be important for the morphology and quality of the final metal carbide films. In order to form smooth films, the polymer solution must have suitable rheological properties so that any spin-coated film has no undesired patterns associated with polymer rheological properties.

The soluble polymer also functions as binding agent to metal in the precursor solution in assisting the formation of the deposited polymer-and-metal containing film and ultimately a metal carbide film. The polymer should have suitable interactions with metal ions that prevent phase separation during deposition. Thereafter, the deposited polymer-metal composite films are heated at high temperatures (calcined), e.g., at temperatures above about 450° C. to obtain the metal carbide films. The soluble polymer selection should also have a clean decomposition under such calcination conditions so that the final metal carbide film can be free of side products.

Metals suitable for the formation of metal carbide films according to this invention are scandium, yttrium, titanium, zirconium, hafnium, vanadium, niobium, tantalum, chromium, molybdenum, tungsten, boron, aluminum and silicon. The transition metals are from Groups 3-6, boron and aluminum are from group 13, and silicon is from group 14 of the periodic table of the elements. Carbides of the lanthanide metals and the actinide metals may also be prepared using the process of this invention. For purposes of this invention, boron and silicon is being treated as metals and therefore a silicon carbide film, for example, for purposes of this invention is treated as a metal carbide film, and a silicon containing precursor is treated as a metal containing precursor the same way that a titanium containing precursor, a niobium containing precursor, a vanadium containing precursor, and a tantalum containing precursor are treated as metal containing precursors.

The metal carbide films prepared by the present process can include a metal carbide with a single metal, can be a metal carbide with two metals or three metals or may be a metal carbide including four or more metals. Among the metal carbides that can be prepared by the present process are included metal carbides from Groups 3, 4, 5, and 6 as well as the carbides of silicon, boron, and aluminum. These carbides include silicon carbide, titanium carbide, niobium carbide, vanadium carbide, tungsten carbide, and tantalum carbide. Films with two metals include titanium carbide/niobium carbide, titanium carbide/vanadium carbide, titanium carbide/tantalum carbide, niobium carbide/vanadium carbide, niobium carbide/tantalum carbide, vanadium carbide/tantalum carbide, and the like. Films with three metals include titanium carbide/niobium carbide/vanadium carbide. Films with four metals include titanium carbide/niobium carbide/vanadium carbide/tantalum carbide.

The solvent for dissolution of the soluble polymer can be, e.g., water, lower alcohols such as methanol, ethanol, propanol and the like, acetone, propylene carbonate, tetrahydrofuran, acetonitrile, acetic acids and mixtures thereof such as water and ethanol and the like. As the soluble polymer used in the present invention includes binding properties for the metals or metal precursors used in formation of the metal carbide films, the polymer can help provide the necessary solubility to the respective metals, e.g., metal precursors.

The starting solution is typically maintained at ambient temperatures from about 15° C. to about 30° C., more usually from about 20° C. to about 25° C. Within those temperature ranges and above the higher temperature, the materials added to the solution are soluble. In preparation of solutions used in the present process, the solutions using a polyethylenimine as the metal binding polymer can be filtered prior to use to remove any non-soluble components. Typically, a precursor solution of containing metal and a polyethyleneimine is filtered using an Amicon ultrafiltration unit containing an untrafiltration membrane designed to pass materials having a molecular weight of less than about 3,000 g/mol (e.g., unbound metal, smaller polymer fragments and the like) while retaining the desired materials of a larger size. Ultrafiltration allows for removal of any unwanted salts such as cations, anions or other impurities.

The metal ratio can be controlled through appropriate addition of metal precursors to a solvent used in the deposition. Such solutions can generally have a shelf life of more than a year.

The homogeneous coating solution can be deposited on a desired substrate, such as a sapphire substrate or a silicon substrate, e.g., by spray coating, dip coating, spin coating, ink jet printing and the like. After deposition of the homogeneous coating solution onto the substrate, the deposited coating must be heated at high temperatures (i.e. calcined) of from about 250° C. to about 1300° C., preferably from about 400° C. to about 1200° C. for a period of time sufficient to remove the polymer and to form the metal carbide film. Heating times may be varied and may be longer depending upon the thickness of the deposited film.

Optionally, the deposited coating can be initially dried by heating to temperatures of from about 50° C. to about 150° C. for from about 15 minutes to several hours, preferably for less than one hour. The deposited polymer-metal carbide film undergoes removal of a percentage of volatile species, mostly water, during such an initial drying stage.

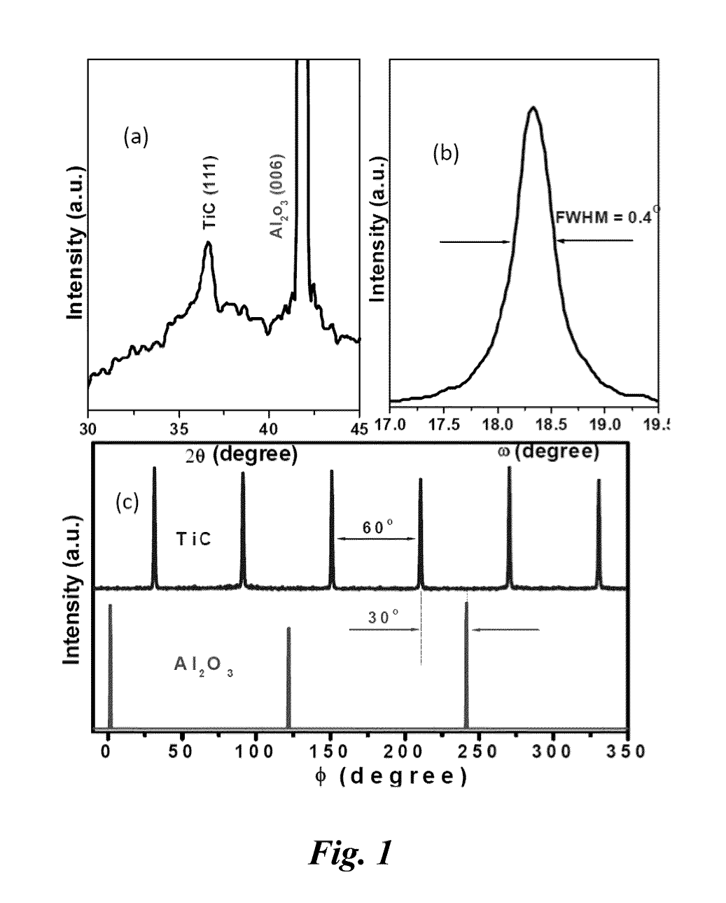

The resultant metal carbide films from the present process have been optical quality films in that they are highly smooth films with a mirror-like appearance. Many of the films have been found to be epitaxial in structure. For example, FIG. 1 shows various plots from X-ray data obtained for a titanium carbide film on a sapphire substrate prepared according to an embodiment of this invention. The X-ray data show that this titanium carbide film is a highly aligned film.

In an aspect of the present invention, composites can be prepared including the various metal-containing films as described with various additional additives to provide tailoring of the material properties. Included among the possible additives are nanofibers such as carbon nanotubes. The carbon nanotubes affect the properties of the film, such as the critical current density of a superconducting film. Before the composite material, some terminology related to current, current density, critical current, and critical current density will be described.

Current is the rate of flow of electric charge, usually represented by the equation I=Q/t wherein I is the current in amperes, Q is the charge in coulombs, and t is the time in seconds. The current density is the current divided by the cross sectional area through which it flows. The current therefore, is current density multiplied by the cross sectional area through it flows. Critical current is critical current density multiplied by cross sectional area. Critical current density (“Jc”) is the maximum current density that can be transported by a particular superconductor material without losing its superconductivity. If the current through a superconductor increases beyond the critical current for that superconductor, the superconductivity vanishes and the material loses its superconductivity and returns to a non-superconductive state. The critical current density is one of the most important electrical parameters of a superconductor because a large current is often needed for many applications. When the superconducting properties of materials are compared, those materials having a greater critical current density (Jc) use a smaller cross-sectional area, or smaller volume, to carry the same amount current compared to materials with a smaller Jc. Using materials with a higher Jc reduces the cost of raw materials and cost of producing the superconducting components.

In an embodiment, a composite film of niobium carbide and carbon nanotubes, using an aligned array of carbon nanotubes was prepared. The critical current density (“Jc”) of the film was measured and compared to the Jc of a film of niobium carbide prepared without the carbon nanotubes. The Jc of the composite film was significantly higher than the Jc of the film without the carbon nanotubes.

The present invention enables the processing of metal carbide films with convenience and flexibility required in industrial fabrication. This process involves making metal carbide films from solutions - optionally in an organic solvent-free process. Films of titanium carbide, niobium carbide, vanadium carbide, tungsten carbide, tantalum carbide, and silicon carbide have been prepared using polymer-assisted deposition (“PAD”) techniques. X-ray diffraction measurement indicates that the titanium carbide and niobium carbide films on r-plane and c-plane sapphire substrates are preferentially oriented along the (100). They are also epitaxial as confirmed from x-ray -scans of the (101) diffraction of the films and transmission electron microscopy.

The polymer is used to bind metals and metal precursors. This allows the removal of any unwanted anions or cations by filtration, e.g., through an Amicon ultrafiltration unit, and brings multiple metals together in a homogeneous manner at a molecular level. This also prevents selective precipitation of unwanted metal phases as a portion of the water can be removed and the metals concentrated within the remaining solution. The present invention can control the relative metal concentrations at the molecular level for mixed metal carbides (TiC/NbC, for example). This can be done, for example, by adding a single polymer (such as carboxylated polyethyleneimine) to a solution containing simple salts (such as nitrate) of two or more metals in the correct ratio. If the binding constant is high for both metals then they will remain in the correct ratio during filtration and concentration of the polymer. Alternatively, each metal can be bound to a polymer, and then the metals can be mixed and the resulting solution can be concentrated and then examined by ICP to determine metal content and then mixed appropriately prior to spin coating. Different polymers and different solvents can be used for different metals in this system.

The present invention is more particularly described in the following examples which are intended as illustrative only, since numerous modifications and variations will be apparent to those skilled in the art.

### EXAMPLE 1

A precursor solution for making titanium carbide films was prepared as follows: 12 grams (“g”) of hexafluorotitanic acid (H₂TiF₆, ALDRICH, 99.9%, 60% in water) was added to 7.5 g of a solution of polyethyleneimine (“PEI”) (purchased from BASF CORPORATION, Clifton N.J., used without further purification) and 40 mL of water purified to 18 MΩ.cm using a MILLI-Q water treatment system. The resulting solution was purified by ultrafiltration, which was carried out using Amicon stirred cells and a 3,000 molecular weight cut-off ultrafiltration membrane under 60 psi argon pressure. Titanium analysis was conducted using a HORIBA JOBIN YVON ULTIMA II inductively coupled plasma-atomic emission spectrometer (“ICP-AES”) following the standard SW846 EPA (Environmental Protection Agency) method 6010 procedure. Analysis showed that the final Ti precursor solution was 496 millimolar (“mM”) in Ti.

### EXAMPLE 2

A precursor used for making niobium carbide films was prepared as follows: NbCL₅ (>99% pure), NH₄OH, and 20% HF were dissolved in water where the water was purified using the Milli-Q water treatment system. Ultrafiltration was carried out under 60 psi nitrogen pressure using Amicon stirred cells with a 3000 molecular weight cut-off. In detail, 2 g of NbCl₅ were converted to Nb(OH)₅ by addition of ammonium hydroxide into the solution. The Nb(OH)₅ was then dissolved in 30 mL of deionized water and 7.5 mL of 20% HF. PEI was then added in 31 g aliquots (total of 3.0 g) and mixed after each addition. After stirring, the solution was placed in an Amicon filtration unit containing a filter designed to pass materials with molecular weight <3,000 g/mol. The solution was diluted 3 times to 200 mL and then purified by ultrafiltration, which resulted in a final volume of about 35 mL in volume. Inductively coupled plasma-atomic emission spectroscopy showed that the final solution was 400 mM in Nb.

### EXAMPLE 3

A precursor solution for making tantalum carbide films was prepared as follows: tantalum chloride was dissolved in water Ammonium hydroxide was added, which resulted in precipitation of tantalum hydroxide (Ta(OH)₅). The precipitate was rinsed with copious amounts of deionized water to remove chloride from the precipitate. The precipitate was then dissolved in 20% HF solution to form a tantalum fluoride complex. PEI was added to this solution, and afterward, ultrafiltration was carried out using Amicon stirred cells and a 3,000 molecular weight cut-off ultrafiltration membrane under 60 psi argon pressure. Inductively coupled plasma-atomic emission spectroscopy showed that the final solution was 214 mM in tantalum.

### EXAMPLE 4

A precursor solution for making vanadium carbide films was prepared as follows: 2 g sodium vanadate was dissolved in 40 ml of water containing 2 g of PEI polymer. The resulting solution was purified by ultrafiltration using Amicon stirred cells and a 3,000 molecular weight cut-off ultra filtration membrane under 60 psi argon pressure to give a solution with 134 mM for vanadium concentration as measured by inductively coupled plasma-atomic emission spectroscopy.

### EXAMPLE 5

A precursor solution for making silicon carbide films was prepared as follows: 12 g of fluorosilcic acid, H₂SiF₆ (25 wt % H₂SiF₆ in water) was mixed with 3.0 g PEI in 40 mL of water. After stirring, a few drops of 20% HF solution were added to remove any cloudiness, and the resulting solution was placed in an Amicon filtration unit containing a filter designed to pass materials having a molecular weight <3,000 g/mol. The solution was diluted to 200 mL, and then purified by ultrafiltration, which resulted in a final volume of 35 mL in volume. Inductively coupled plasma-atomic emission spectroscopy showed that the final solution was 456 mM in Si.

### EXAMPLE 6

A precursor solution for making silicon carbide films was prepared as follows: 8 g of water glass (50 wt % sodium silicate in water) was added to 30 mL of water. PEI (7 g) was then added and the solution mixed until the PEI dissolved. The solution was placed in an Amicon filtration unit containing a filter designed to pass materials having a molecular weight <3,000 g/mol. The solution was diluted to 200 mL and then concentrated to approximately 50 mL in volume; this procedure was repeated 5 times to remove the sodium. Inductively coupled plasma-atomic emission spectroscopy showed that the final solution was 473 mM in Si.

### EXAMPLE 7

A precursor solution for making tungsten carbide films was prepared as follows: An amount of 7.0 grams of polyethylenimine was dissolved in 70 mL of water. An amount of 8 g of sodium tungstate was added and the resulting solution was titrated to pH 4 using 10% HCl. The resulting solution was stirred, then filtered through CELITE® and diatomaceous earth, and then placed in an Amicon filtration unit containing a PM 10 filter designed to pass materials having a molecular weight <10,000 g/mol. The solution was diluted to 200 mL and then purified by untrafiltration which resulted in concentrating the solution to a volume of 80 mL. This process was repeated three times to remove the unwanted sodium. Inductively coupled plasma-atomic emission spectroscopy showed that the final was 257 mM in W.

### EXAMPLE 8

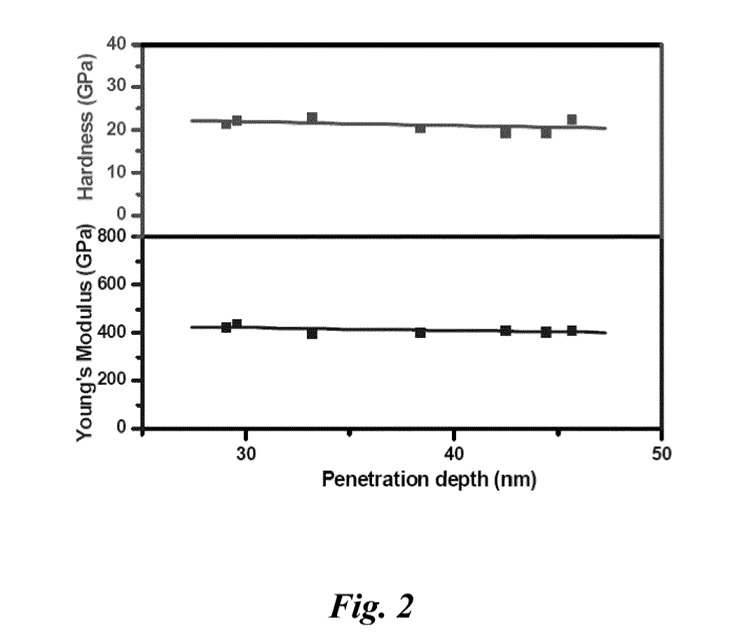

A titanium carbide film was prepared as follows: precursor solution from Example 1 was spin-coated on a c-plane sapphire substrate at 3000 rpm for 20 s. The film was heated to 650° C. at a rate of 10° C./min in mixed gases of ethylene (10 sccm) and forming gas (10 sccm) and annealed at 650° C. for 2 h. The sample was then annealed in Ar gas (10 sccm) by increasing the temperature from 650° C. to 1000° C. in one hour. The temperature was held at 1000° C. for 3 h. Finally, the temperature of the furnace was decreased to room temperature by turning off the power supply to the furnace. The thickness of film is about 40 nm for one spin-coat. FIGS. 1(a), 1(b), and 1(c) shows x-ray diffraction (“XRD”) patterns of this titanium carbide film grown on the on c-plane sapphire substrate; FIG. 1(a) shows a θ-2θ scan; FIG. 1(b) shows a rocking curve from a (111) reflection; and FIG. 1(c) show a φ scan from a (200) reflection of the titanium carbide film and a φ scan from a (104) reflection of the Al₇O₃ substrate. Beginning with FIG. 1(a), the intensity in arbitrary units (a.u.) is plotted on the y-axis while 2θ in degrees is on the x-axis of the plot. The x-axis range is from 30 degrees to 45 degrees. The plot shows two reflections. The reflection at approximately 37 degrees is attributed to a (111) reflection from titanium carbide. The reflection at approximately 42 degrees is very sharp and is the most intense reflection in the diffraction pattern and is attributed to a (006) reflection from the sapphire substrate (it is labeled Al₂O₃ (006) in the Figure). FIG. 1(b) shows a plot of intensity in arbitrary units (a.u.) versus ω in degrees on the x-axis. The range of ω is from 17.0 degrees to 19.5 degrees. FIG. 1(b) shows a peak centered at approximately 18.3 degrees having a full width at half maximum (FWHM) equal to 0.4 degrees. FIG. 1(c) shows a φ scan from a (200) reflection of the titanium carbide film and a φ scan from a (104) reflection of the substrate. The reflection intensity is in arbitrary units (a.u.), and φ in degrees is plotted on the x-axis. There are six sharp reflections from the titanium carbide reflection that appear at values of φ of approximately 30 degrees, 90 degrees, 150 degrees, 210 degrees, 270 degrees, and 330 degrees. Adjacent peaks are separated by a difference of 60 degrees. There are three sharp reflections that appear in the substrate plot (the Figure shows the substrate peaks below those of the titanium carbide and the substrate is indicated also as Al₂O₃, which is the chemical formula of sapphire). The three substrate peaks appear at just above zero degrees, 120 degrees, and 240 degrees. The XRD plots collectively demonstrate that the titanium carbide film has a highly ordered well aligned structure. FIG. 2 shows the hardness measurements of the films. The hardness is in the range from 19.53 to 22.93 GPa through the penetration depth. The hardness decreased slowly as the penetration depth increased. Our titanium carbide film possesses an average hardness of 21.27 GPa, which is as good as the value (−20 GPa) of titanium carbide films by physical vapor depositions. In addition, the Young's modulus of titanium carbide films (as shown in the bottom panel of FIG. 2) has values in the range of from 440 to 396 GPa, which is even higher than that of reported titanium carbide films, although it is lower than that of the bulk titanium carbide which is approximately 450 GPa.

### EXAMPLE 9

A titanium carbide film was prepared as follows: precursor solution from Example 1 was spin-coated on a sapphire substrate at 3000 rpm for 20 s. The film was heated to 650° C. at a rate of 10° C./min in forming gas (10 sccm) then the gas was changed to mixed gases of ethylene (10 sccm) and in forming gas (10 sccm) and annealed at 650 ° C. for 2 h. The sample was then annealed in Ar gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film is about 40 nm for one spin-coat.

### EXAMPLE 10

A titanium carbide film was prepared as follows: precursor solution from Example 1 was spin-coated on a sapphire substrate at 3000 rpm for 20 s, respectively. The film was heated to 650° C. at a rate of 10° C./min in mixed gases of ethylene (10 sccm) and forming gas (10 sccm) and annealed at 650° C. for 2 h. The sample was then annealed in Ar gas (10 sccm) by increasing the temperature from 650° C. to 1000° C. in one hour and staying at 1000° C. for 3 h. Finally, the temperature of the furnace was decreased to room temperature by turning off the power supply to the furnace. The titanium carbide coated sapphire was spin-coated with another layer of Ti precursor solution at 3000 rpm for 20 s.

The film was heated to 650° C. at a rate of 10° C./min in mixed gases of ethylene (10 sccm) and forming gas (10 sccm) and annealed at 650° C. for 2 h. The sample was then annealed in Ar gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film was about 80 nm for two spin-coats.

### EXAMPLE 11

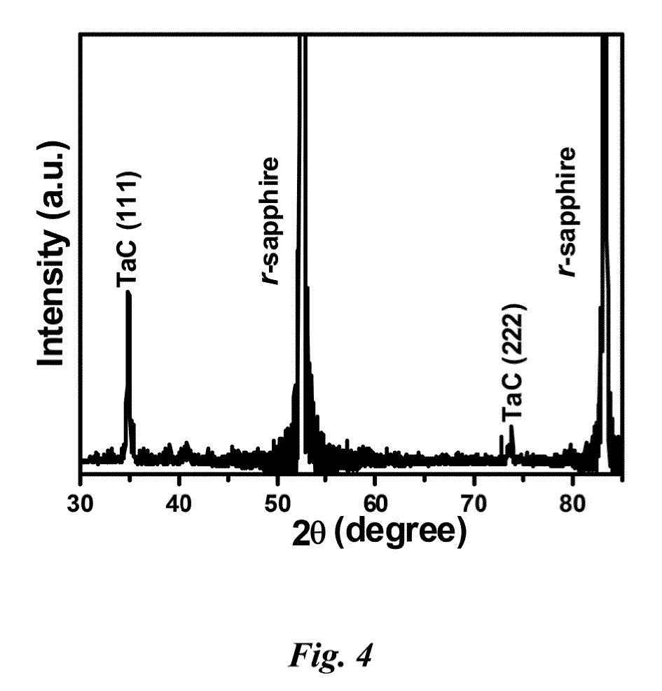

A tantalum carbide film was prepared as follows: precursor solution from Example 3 was spin-coated on a sapphire substrate at 3000 rpm for 20 s. The film was heated to 650° C. at a rate of 10° C./min in mixed gases of ethylene (10 sccm) and forming gas (10 sccm) and annealed at 650° C. for 2 h. The sample was then annealed in Ar gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film is about 40 nm for one spin-coat. FIG. 4 shows an XRD pattern of the tantalum carbide thin film on a sapphire substrate, plotted as intensity on the y-axis in arbitrary units (“a.u.”) of intensity versus 2θ degrees on the x-axis. The x-axis shown is from a 2θ of 30 degrees to 85 degrees. The XRD pattern shows reflections at 2θ values of approximately 35, 53, 74, and 83. The reflection at a 2θ of 35 degrees is due to tantalum carbide (111) and the reflection at a 2θ of 74 degrees is due to tantalum carbide (222). The reflections at 2θ values of 53 degrees and 83 degrees are those of the sapphire substrate. The XRD reflections are very sharp, and the XRD is very clean. Thus, the XRD pattern demonstrates a highly ordered tantalum carbide film and an excellent alignment of the tantalum carbide film with respect to the sapphire substrate.

### EXAMPLE 12

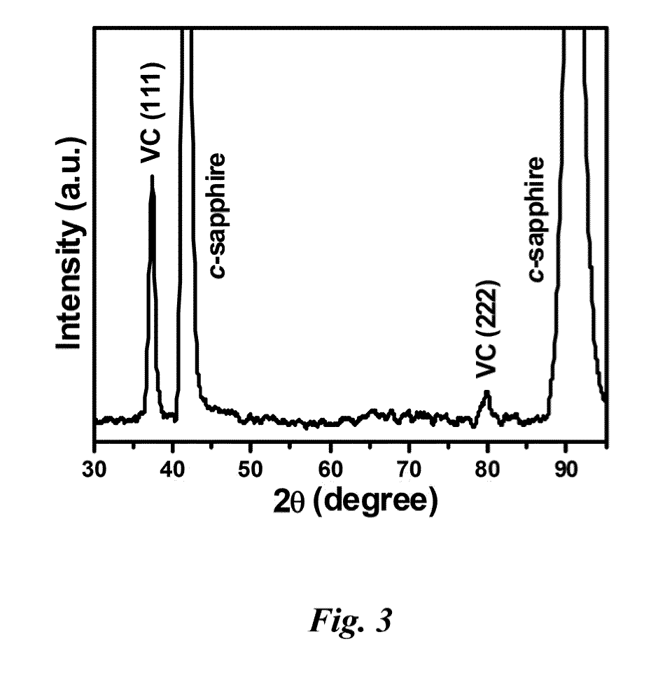

A vanadium carbide film was prepared as follows: precursor solution from Example 4 was spin-coated on sapphire substrate at 3000 rpm for 20 s. The film was heated to 650° C. at a rate of 10° C./min in mixed gases of ethylene (10 sccm) and forming gas (10 sccm) and annealed at 650° C. for 2 h. The sample was then annealed in Ar gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film was about 40 nm for one spin-coat. FIG. 3 shows an XRD pattern of the vanadium carbide film on the sapphire substrate, plotted as intensity in arbitrary units (“a.u.”) of intensity along the y-axis versus 2θ degrees along the x-axis. The x-axis range shown is from a 2θ of 30 degrees to 95 degrees. There are four reflections in the XRD spectrum that appear at 2θ values of approximately 37 degrees, 42 degrees, 80 degrees and 91 degrees. The peak at 37 degrees is attributed to vanadium carbide (111). The peak at 80 degrees is attributed to vanadium carbide (222). The peaks at 42 degrees and 91 degrees are those of the c-sapphire substrate. The XRD peaks are very sharp and the spectrum is otherwise very simple. These diffraction patterns demonstrate a highly ordered vanadium carbide film having excellent alignment with respect to the sapphire substrate.

### EXAMPLE 13

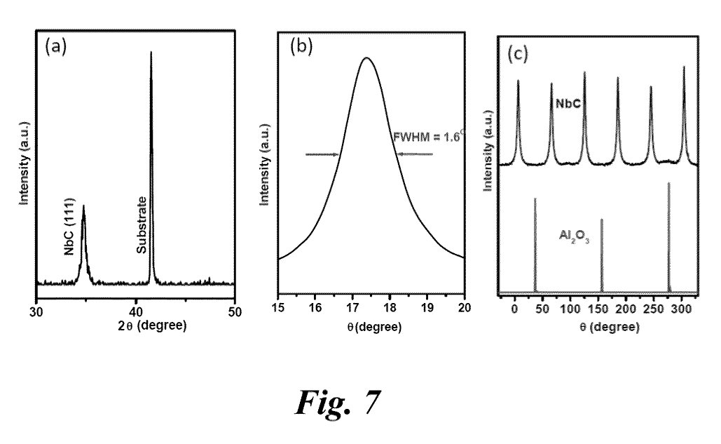

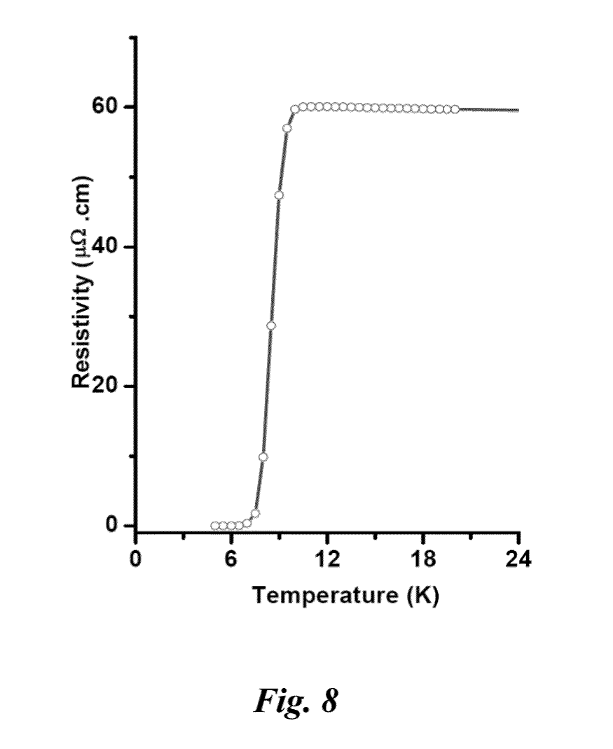

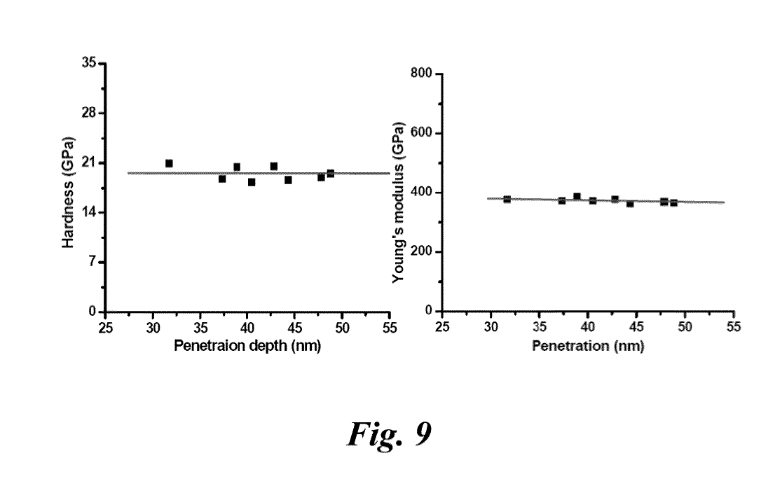

A niobium carbide film was prepared as follows: precursor solution from Example 2 was spin-coated on a (006) sapphire substrate at 3000 rpm for 20 s. The film was heated to 650° C. at a rate of 10° C./min in mixed gases of ethylene (10 sccm) and forming gas (10 sccm) and annealed at 650° C. for 2 h. The sample was then annealed in Ar gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film was about 40 nm for one spin-coat. FIG. 7 shows an XRD pattern of the NbC film on the (006) sapphire substrate; (a.) a θ-2θ scan; (b) a rocking curve from a (111) reflection; and (c) φ-scans from (200) and (104) reflections of the NbC film (top) and the Al₂O₃ substrate (bottom), respectively. The 2θ diffraction pattern shown in FIG. 7a shows only two reflections, that (111) reflection of niobium carbide at ˜34° and the substrate (sapphire) reflection at ˜42°. The rocking curve of the (111) reflection shows a full width at half max (FWHM) of 1.6° indicating good ordering of the film on the sapphire. The electronic properties of this film were excellent as can be seen in FIG. 8. FIG. 8 shows the temperature vs resistance measurement for the niobium carbide film. The sharp drop in resistance at approximately 10 Kelvin is associated with a transition to a superconducting state. The maximum recorded superconducting transition for niobium carbide is 11 Kelvin. The hardness and Young's modulus versus penetration depth for the film are shown in FIG. 9. The graph on the left is hardness versus penetration depth of a NbC film, and the graph on the right is Young's modulus versus penetration depth for the NbC. Have hardness values consistent with the standard hardness of niobium carbide which is 21 GPa.

### EXAMPLE 14

A niobium carbide film was prepared as follows: precursor solution from Example 2 was spin-coated on sapphire substrate at 3000 rpm for 20 s. The film was heated to 650° C. at a rate of 10° C./min in ethylene (10 sccm) and annealed at 650° C. for 2 h. The sample was then annealed in Ar gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of the film was about 40 nm for one spin-coat.

### EXAMPLE 15

A niobium carbide film was prepared as follows: precursor solution from Example 2 was spin-coated on sapphire substrate at 3000 rpm for 20 s. The film was heated to 650° C. at a rate of 10° C./min in ethylene (10 sccm) and hydrogen gas (10 sccm) and annealed at 650° C. for 2 h. The sample was then annealed in hydrogen gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film was about 40 nm for one spin-coat.

### EXAMPLE 16

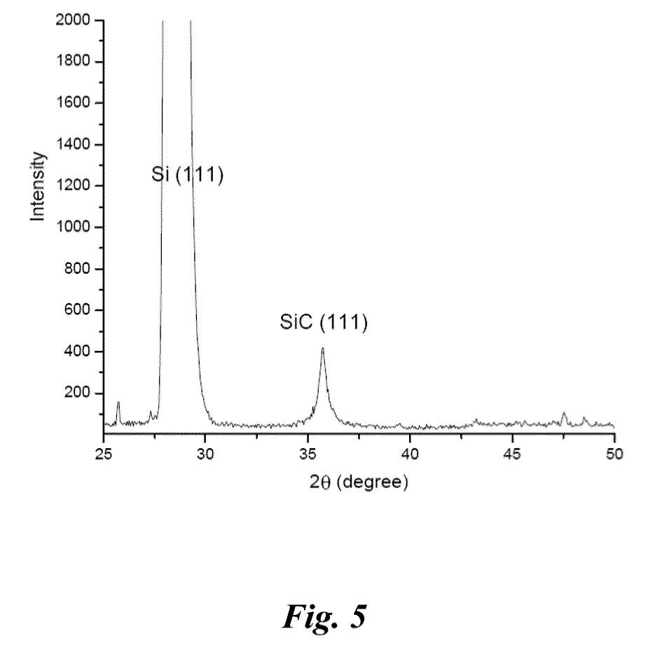

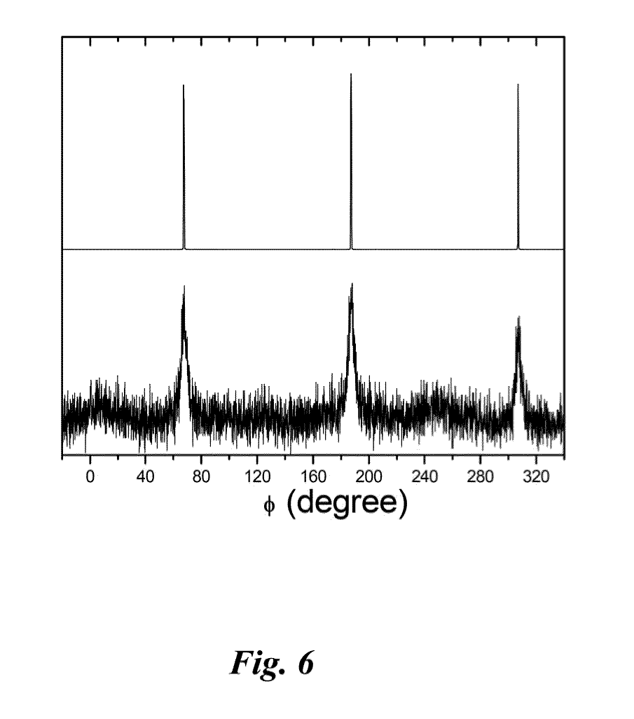

A silicon carbide film was prepared as follows: precursor solution from Example 5 was spin-coated on a silicon substrate at 3000 rpm for 20 s. The film was heated to 650° C. at a rate of 10° C./min in mixed gases of ethylene (10 sccm) and forming gas (10 sccm) and annealed at 650° C. for 2 h. The sample was then annealed in forming gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film was about 40 nm for one spin-coat. FIG. 6 shows a φ scan from a silicon carbide thin film (top panel) on a silicon (111) substrate (bottom panel) film, this demonstrates the high degree of crystallographic alignment between the silicon substrate (bottom panel) and the thin film of silicon carbide (top panel). The θ-2θ scan shown in FIG. 5 has only 2 major reflections, the reflection for the substrate silicon (111) at 28° and a second smaller reflection due to the presence of silicon carbide (111) at 37°. The phi scans are shown in FIG. 6. The lower pattern is due to the silicon substrate and the upper results from the silicon carbide film. The excellent alignment between the substrate and the silicon carbide layer is clearly seen from this XRD analysis.

### EXAMPLE 17

A silicon carbide film was prepared as follows: precursor solution from Example 5 was spin-coated on a silicon substrate at 3000 rpm for 20 s. The film was heated to 650° C. at a rate of 10° C./min in mixed gases of ethylene (10 sccm) and forming gas (10 sccm) and annealed at 650° C. for 2 h. The sample was then annealed in Ar gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film was about 40 nm for one spin-coat.

### EXAMPLE 18

A silicon carbide film was prepared as follows: precursor solution from Example 5 was spin-coated on a quartz substrate at 3000 rpm for 20 s. The film was heated to 650° C. at a rate of 10° C./min in mixed gases of ethylene (10 sccm) and forming gas (10 sccm) and annealed at 650° C. for 2 h. The sample was then annealed in forming gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film was about 40 nm for one spin-coat.

### EXAMPLE 19

A silicon carbide film was prepared as follows: precursor solution from Example 6 was spin-coated on a silicon substrate at 3000 rpm for 20 s. The film was heated to 650° C. at a rate of 10° C./min in mixed gases of ethylene (10 sccm) and forming gas (10 sccm) and annealed at 650° C. for 2 h. The sample was then annealed in forming gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film was about 40 urn for one spin-coat.

### EXAMPLE 20

A silicon carbide film was prepared as follows: precursor solution from Example 6 was spin-coated on a silicon substrate at 3000 rpm for 20 s. The film was heated to 650° C. at a rate of 10° C./min in mixed gases of ethylene (10 sccm) and forming gas (10 sccm) and annealed at 650° C. for 2 h. The sample was then annealed in Ar gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film was about 40 nm for one spin-coat.

### EXAMPLE 21

A silicon carbide film was prepared as follows: precursor solution from Example 6 was spin-coated on a quartz substrate at 3000 rpm for 20 s. The film was heated to 650° C. at a rate of 10° C./min in mixed gases of ethylene (10 sccm) and forming gas (10 sccm) and annealed at 650° C. for 2 h. The sample was then annealed in forming gas (10 sccm) by increasing the temperature from 650° C. to 1000° C. in one hour and staying at 1000° C. for 3 h. Finally, the temperature of the furnace was decreased to room temperature by turning off the power supply to the furnace. The thickness of film is about 40 nm for one spin-coat.

### EXAMPLE 22

A mixed metal carbide film of titanium carbide and vanadium carbide was prepared as follows: A 1:1 molar ration of the precursor solutions from Example 1 and Example 4 were mixed together and then this solution was then spin-coated onto a sapphire substrate at 3000 rpm for 20 s. The film was heated to 650° C. at a rate of 10° C./min in mixed gases of ethylene (10 sccm) and forming gas (10 sccm) and annealed at 650° C. for 2 h. The sample was then annealed in Ar gas (10 sccm) by increasing the temperature from 650° C. to 1000° C. in one hour and staying at 1000° C. for 3 h. Finally, the temperature of the furnace was decreased to room temperature by turning off the power supply to the furnace.

### EXAMPLE 23

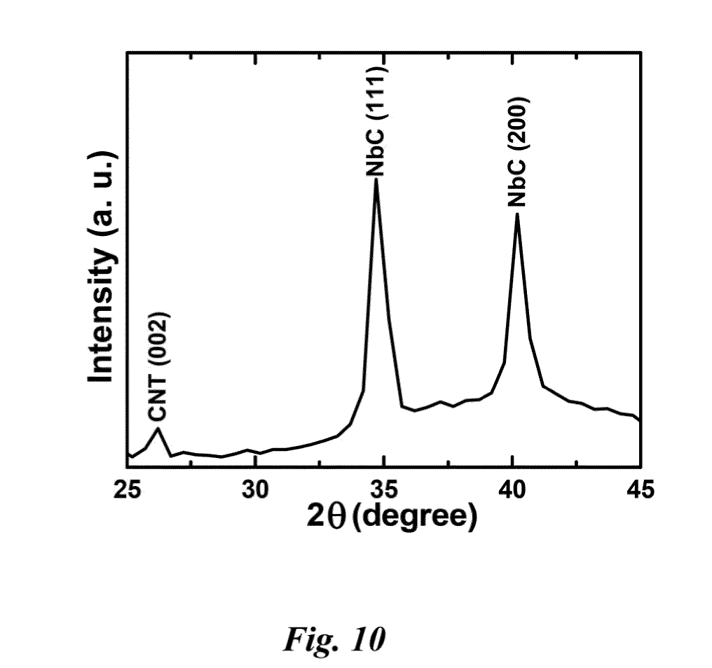

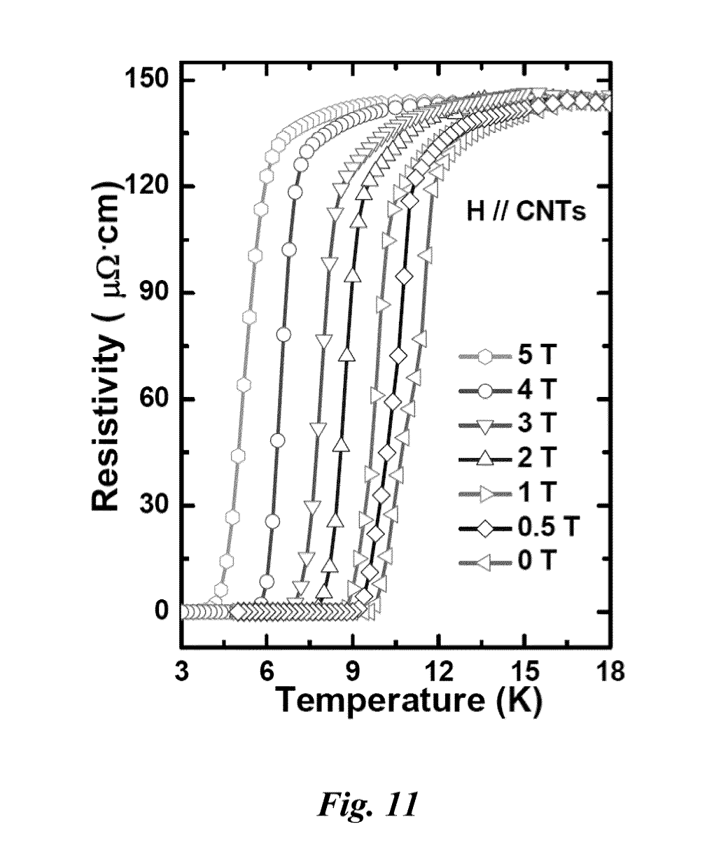

A composite film of niobium carbide and carbon nanotubes was prepared as follows: an amount of the precursor solution of Example 2 was allowed to permeate through an aligned array of carbon nanotubes. The resulting film was heated to 650° C. at a rate of 10° C./min in mixed gases of ethylene (10 sccm) and forming gas (10 sccm) and annealed at 650° C. Thereafter, the mixture gases were switched off, and the Ar gas flow or forming gas was turned on. The temperature was ramped to 1000° C., and the sample was annealed for 3 h. Finally, the temperature of the furnace was allowed to decrease to room temperature naturally. FIG. 10 shows an XRD pattern of the NbC-carbon nanotube composite film. FIG. 10 shows plot of XRD spectrum of the composite film of niobium carbide and aligned array of carbon nanotubes. The y-axis displays intensity in arbitrary units (a.u.) of intensity, and the x-axis is 2θ degrees ranging from 25 degrees to 45 degrees. The plot shows three reflections. There is a reflection at a 2θ value of approximately 26 degrees that is attributed to a (002) reflection from the carbon nanotubes. There are also reflection at 2θ values of approximately 35 degrees and 40 degrees. The peak at 35 degrees is attributed to a (111) reflection from niobium carbide, and the peak at 40 degrees is attributed to a (200) reflection also from niobium carbide. The XRD spectrum demonstrates the formation of the niobium carbide materials and the incorporation of the carbon nanotubes within the film. The carbon nanotubes have maintained their structural identity and have not been destroyed but the deposition process. The fact that the composite material has different properties is clearly demonstrated by the measurement of the critical current density (Jc). In FIG. 11 we plot the temperature vs. resistivity for the composite material as a function of applied magnetic field. The niobium carbide-carbon nanotube composite demonstrates a much greater critical current density (Jc) than the pure niobium carbide.

### EXAMPLE 24

A composite film of niobium carbide and carbon nanotubes was prepared as follows: precursor solution from Example 2 was allowed to permeate through a carbon nanotube aligned array. The sample was heated to 650° C. in ethylene (10 sccm) and annealed at 650° C. Thereafter, the mixture gases were switched off, and the Ar gas flow or forming gas was turned on. The temperature was ramped to 1000° C., and the sample was annealed for 3 h. Finally, the temperature of the furnace was allowed to decrease to room temperature naturally. The material obtained was basically identical to that seen in example 23.

### EXAMPLE 25

A tungsten carbide film was prepared as follows: precursor solution from Example 7 was spin-coated on a silicon substrate at 3000 rpm for 20 s. The film was heated to 650° C. at a rate of 10° C./min in methane gas (10 sccm) and annealed at 650° C. for 2 h. The sample was then annealed in argon increasing the temperature from 650° C. to 1000° C. in one hour and staying at 1000° C. for 3 h. Finally, the temperature of the furnace was decreased to room temperature by turning off the power supply to the furnace.

### EXAMPLE 26

A precursor solution for making yttrium carbide films was prepared as follows: an amount of 1.0 gram of ethylenediaminetetraaceticacid (“EDTA”) was placed in a 50 mL Falcon tube and 25 mL of water were added. The EDTA does not dissolve at this stage. An amount of 1.0 gram of polyethylenimine (from BASF) was added to the solution and the solution was agitated until the EDTA and the polyethylenimine were in solution. Then 1.36 grams of yttrium nitrate hexahydrate were added. The solution was stirred and then placed in an Amicon ultrafiltration unit containing a PM 10 ultrafiltration membrane designed to pass materials having a molecular weight <10,000 g/mol. The solution was diluted to 200 mL and then subjected to ultrafiltration which resulted in final volume of 10 mL. Inductively coupled plasma-atomic emission spectroscopy showed that the final solution had 15.3 mg/mL of Y.

### EXAMPLE 27

A precursor solution for making zirconium carbide films was prepared as follows: An amount of 1.0 grams of dipotassium ethylenediaminetetraacetic acid was dissolved in 30 mL of water. To this solution was added 2.0 grams of zirconyl nitrate (35 wt % in water) and the solution was stirred. An amount of 1.0 gram of polyethylenimine was then added to the solution and the solution was stirred. The resulting solution is clear and has a pH of 8.0. This solution was placed in an Amicon ultrafiltration unit containing a PM 10 ultrafiltration membrane designed to pass materials having a molecular weight <10,000 g/mol. The solution was diluted to 200 mL with absolute ethanol and then subjected to untrafiltration which resulted in a volume of 10 mL Inductively coupled plasma-atomic emission spectroscopy showed that the final solution had 19.3 mg/mL of Zr.

### EXAMPLE 28

A precursor solution for making aluminum carbide films was prepared as follows: Fluorinated polyethyleneimine polymer was prepared by slowing adding an amount of 5 mL of 48% hydrofluoric acid to an amount of 10 g of polyethyleneimine in 40 mL water while maintaining pH at 7. An amount of 2.0 g of aluminum nitrate hydrate was added to 3 g of the fluorinated polyethyleneimine polymer in 40 ml, water. The final concentration of Al was 200.6 mM.

### EXAMPLE 29

A precursor solution for making aluminum carbide films was prepared as follows: An amount of 2.0 grams of EDTA was placed in a 50 mL Falcon tube and 40 mL of nanopure water were added. The EDTA does not dissolve at this stage. An amount of 2.6 g of aluminum nitrate nonahydrate was added to the solution, followed by the addition of 2.2 g of polyethylenimine (BASF) and the solution was agitated until everything was dissolved. The solution was stirred and then placed in an Amicon filtration unit containing a PM 10 filter designed to pass materials having a molecular weight <10,000 g/mol. The solution was diluted to 200 mL and then subjected to ultrafiltration, which concentrated it to a volume of 10 mL The final concentration of aluminum was 119 mM.

### EXAMPLE 30

A precursor solution for making boron carbide films was prepared as follows: An amount of 0.34 g of potassium borohydride was added to a solution of polyethylenimine (0.35 g) in 10 mL of water. The mixture was stirred until no solid remained, and was then placed in an Amicon filtration unit containing a PM 10 filter designed to pass materials having a molecular weight <10,000 g/mol. The solution was diluted to 200 mL and then subjected to ultrafiltration, which resulted in a volume of 10 mL. The final concentration of aluminum was 105 mM.

### EXAMPLE 31

A precursor solution for making hafnium carbide films was prepared as follows: 2.0 g of HfOCL₂ (ALDRICH, 99.99% pure), 2.0 g HEDTA, 2.0 grams polyethylenimine polymer (BASF), and concentrated ammonium hydroxide (FISHER) in deionized (18 MOhms) H₂O were mixed together until a clear solution was produced. The resulting solution was filtered through a 0.45 micron filter, diluted to 200 mL with nano pure water, and purified by Amicon filtration with a 3,000 MW cut-off filter. The final concentrated solution was 163 mM Hf, determined by ICP/AES. This solution was rotovapped to further concentrate it, resulting in a final concentration of 250 mM Hf.

### EXAMPLE 32

A precursor solution for making lanthanum carbide films was prepared as follows: The La precursor was made by adding 2.6 grams lanthanum nitrate hydrate (99.999%, ALDRICH) to 20-mLs water purified to 18Ω and dissolved. 2 grams EDTA (Aldrich 99.995%)was added to the solution, followed by 2.5 grams PEI purchased from BASF Corporation of Clifton, N.J., and used without further purification. 2-mLs concentrated NH₄OH was added to facilitate dissolution. Ultrafiltration was carried out using Amicon stirred cells and 10,000 molecular weight cut-off ultrafiltration membrane under 60 psi argon pressure. Metal analysis was conducted with a Horiba Jobin Yvon Ultima II inductively coupled plasma-atomic emission spectrometer (ICP-AES) following the standard SW846 EPA (Environmental Protection Agency) method 6010 procedure. The resulting La concentration was 220 mM.

### EXAMPLE 33

The scandium precursor solution was made by adding 3.0 grams scandium trichloride (99.9%, STREM) to 20-mLs water purified to 18Ω and dissolved. 5.92 grams EDTA (Aldrich 99.995%) were added to the solution, followed by 5.82 grams PEI purchased from BASF Corporation of Clifton, N.J., and used without further purification. Ultrafiltration was carried out using Amicon stirred cells and 10,000 molecular weight cut-off ultrafiltration membrane under 60 psi argon pressure. Metal analysis was conducted with a Horiba Jobin Yvon Ultima II inductively coupled plasma-atomic emission spectrometer (ICP-AES) following the standard SW846 EPA (Environmental Protection Agency) method 6010 procedure. The resulting Lu concentration was 145 mM at pH 6.94.

### EXAMPLE 34

A solution including titanium and hydrogen peroxide and PEI and EDTA was prepared as follows: A solution of soluble titanium was prepared by placing 2.5 grams of 30% hydrogen peroxide into 30 mL of water and then slowly adding 2.5 grams of titanium tetrachloride. Small aliquots of the titanium solution were then added to a solution containing 1 g EDTA and 1 g of PEI in 40 mL of water. The pH was monitored and as the pH decreased below pH 3.5, aliquots of 10% NaOH were added to raise the pH to pH 7.5. This process was repeated until addition of the titanium solution resulted in a precipitate that would not dissolve. The precipitate was removed by filtration and the filtrate was placed in an Amicon ultrafiltration unit containing an ultrafiltration membrane designed to pass materials having a molecular weight <30,000 g/mol. The solution was diluted to 200 mL and then subjected to ultrafiltration which resulted in a volume of 10 mL This dilution and ultrafiltration process was repeated two more times. Inductively coupled plasma-atomic emission spectroscopy showed that the final solution was 461mM Ti.

### EXAMPLE 35

A solution including boron and PEI and EDTA was prepared as follows. Boric acid (1 g) was added to a solution of 1 g of PEI in 40 mL of water. The solution was then placed in an Amicon ultrafiltration unit containing an ultrafiltration membrane designed to pass materials having a molecular weight <30,000 g/mol. The solution was diluted to 200 mL and then subjected to ultrafiltration, resulting in a volume of 10 mL. This dilution and ultrafiltration process was repeated two more times. Inductively coupled plasma-atomic emission spectroscopy showed that the final solution was 727 mM B.

### EXAMPLE 36

A solution including vanadium EDTA and PEI was prepared as follows: Vanadyl sulfate hydrate (0.6g) was added to a solution of 1.0 g EDTA in 40 mL of water. The solution was mixed and 1.0 g of PEI was added. The solution was then filtered through a 0.45 micron filter and placed in an Amicon ultrafiltration unit containing an ultrafiltration membrane designed to pass materials having a molecular weight <30,000 g/mol. The solution was diluted to 200 mL and then subjected to ultrafiltration resulting in a volume of 10 mL, and this dilution and ultrafiltration process was repeated three more times. Inductively coupled plasma-atomic emission spectroscopy showed that the final solution was 218 mM V.

What is claimed is:

1. A process for preparing a metal carbide film comprising:
depositing a homogeneous coating solution onto a substrate to form a coated substrate, the coating solution including a soluble metal precursor, a soluble polymer and a suitable solvent, the soluble metal precursor including a metal selected from scandium, yttrium, titanium, zirconium, hafnium, vanadium, niobium, tantalum, chromium, molybdenum, tungsten, boron, aluminum and silicon, the soluble polymer binding to the soluble metal precursor, and
heating the coated substrate in a reducing atmosphere that includes a carbon source gas at temperatures and for times characterized as sufficient to remove the polymer and form a metal carbide film on the support.

2. The process of claim 1, further comprising:
forming a homogeneous coating solution by mixing together a soluble polymer selected from polyethyleneimine and polyethyleneimine derivatives, a soluble metal precursor having a metal selected from scandium, yttrium, titanium, zirconium, hafnium, vanadium, niobium, tantalum, chromium, molybdenum, tungsten, boron, aluminum and silicon, and a suitable solvent to form a first solution and then purifying the first solution by ultrafiltration to form the homogeneous coating solution.

3. The process of claim 1, further comprising:
forming the homogeneous coating solution by:
preparing a first homogeneous solution by mixing together a soluble polymer selected from polyethyleneimine and polyethyleneimine derivatives; a metal compound having a metal selected from titanium, niobium, vanadium, silicon, and tantalum; and a suitable solvent, then purifying the solution by ultrafiltration, and then
preparing a second homogeneous solution by mixing together a soluble polymer selected from polyethyleneimine and polyethylene derivatives, a metal compound having a metal selected from scandium, yttrium, titanium, zirconium, hafnium, vanadium, niobium, tantalum, chromium, molybdenum, tungsten, boron, aluminum and silicon, and a suitable solvent, then purifying the second homogeneous solution by ultrafiltration, and then mixing the first and second homogeneous solutions together to form the homogeneous coating solution.

4. The process of claim 1, wherein the suitable solvent is selected from water, lower alcohols, acetone, tetrahydrofuran, propylene carbonate, acetonitrile, ethylacetate, acetic acid, and mixtures thereof.

5. The process of claim 1, wherein said solvent is water and is organic-solvent free.

6. The process of claim 1, wherein said coating solution is deposited onto the substrate by spin coating, dipping, spraying, or ink jetting onto the substrate.

7. The process of claim 1, wherein the substrate comprises sapphire or silicon.

8. The process of claim 1, wherein the carbon source gas is ethylene.

9. The process of claim 1, wherein the coating solution includes both titanium and niobium.

10. The process of claim 1, wherein the reducing atmosphere includes forming gas.

11. The process of claim 1, wherein the metal carbide film is highly ordered.

12. A process for preparing a metal carbide film comprising:
depositing a homogeneous coating solution onto a substrate to form a coated substrate, the coating solution including a soluble metal precursor, a soluble polymer and a suitable solvent, the soluble metal precursor including a metal selected from scandium, yttrium, titanium, zirconium, hafnium, vanadium, niobium, tantalum, chromium, molybdenum, tungsten, boron, aluminum and silicon, the soluble polymer binding to the soluble metal precursor, and
heating the coated substrate in a reducing atmosphere that includes inert gas and hydrogen at temperatures and for times characterized as sufficient to evaporate the solvent and remove the polymer,
adding a carbon source gas to the reducing atmosphere and heating at temperatures and for times characterized as sufficient to form a metal carbide film on the support,
discontinuing adding the carbon source gas to the reducing atmosphere, and
heating the metal film on the support at temperatures and for times characterized as sufficient to anneal the metal carbide film.

13. A composite comprising a substrate and a film on the substrate wherein the film comprises a composite of niobium carbide and carbon nanotubes, the film having a critical current density Jc greater than the Jc of niobium carbide.
